(19) United States
(12) Patent Application Publication
(10) Pub. No.: US 2015/0227230 A1
(43) Pub. Date: Aug. 13, 2015

(54) MICRO-WIRE TOUCH SCREEN WITH THIN COVER

(71) Applicants: RONALD STEVEN COK, Rochester, NY (US); Mitchell Stewart Burberry, Webster, NY (US); Kam Chuen Ng, Rochester, NY (US)

(72) Inventors: RONALD STEVEN COK, Rochester, NY (US); Mitchell Stewart Burberry, Webster, NY (US); Kam Chuen Ng, Rochester, NY (US)

(21) Appl. No.: 14/178,567

(22) Filed: Feb. 12, 2014

(51) Int. Cl. G06F 3/044

(52) U.S. Cl. CPC G06F 3/044

(57) ABSTRACT

A micro-wire touch-screen device includes a transparent layer having a surface, a plurality of drive electrodes formed in relation to the transparent layer, and a plurality of sense electrodes formed in relation to the transparent layer. Each drive electrode includes a plurality of electrically connected drive micro-wire and each sense electrode includes a plurality of electrically connected sense micro-wires. The sense micro-wires are electrically isolated from the drive micro-wires. The transparent layer is disposed such that the location of the transparent layer surface is selected to be greater than zero and less than 500 microns from the sense electrodes in a direction perpendicular to the transparent layer surface. The drive electrodes and the sense electrodes form a capacitive touch sensor that does not experience false release.

### FIELD OF THE INVENTION

The present invention relates to touch screens having micro-wire electrodes.

### BACKGROUND OF THE INVENTION

Touch screens with transparent electrodes are widely used with electronic displays, especially for mobile electronic devices. Such devices typically include a touch screen mounted over an electronic display that displays interactive information. Touch screens mounted over a display are largely transparent so that a user can view displayed information through the touch screen and readily locate a point on the touch screen to touch and thereby indicate the information relevant to the touch. By physically touching, or nearly touching, the touch screen in a location associated with particular information, a user can indicate an interest, selection, or desired manipulation of the associated particular information. The touch screen detects the touch and then electronically interacts with a processor to indicate the touch and touch location. The processor can then associate the touch and touch location with displayed information to execute a programmed task associated with the information. For example, graphic elements in a computer-driven graphic user interface are selected or manipulated with a touch screen mounted on a display that displays the graphic user interface.

Touch screens use a variety of technologies, including resistive, inductive, capacitive, acoustic, piezoelectric, and optical technologies. Such technologies and their application in combination with displays to provide interactive control of a processor and software program are well known in the art. Capacitive touch screens are of at least two different types: self-capacitive and mutual-capacitive. Self-capacitive touch screens employ an array of transparent electrodes, each of which in combination with a touching device (e.g. a finger or conductive stylus) forms a temporary capacitor whose capacitance is detected. Mutual-capacitive touch screens can employ two overlapping orthogonal sets of transparent electrodes that form an array of capacitors, each of whose capacitance is affected by a conductive touching device. In either case, each capacitor is tested to detect a touch and the physical location of the overlap in the touch screen corresponds to the location of the touch. For example, U.S. Pat. No. 7,663,607 discloses a multipoint touch screen having a transparent capacitive sensing medium configured to detect multiple touches or near touches that occur at the same time and at distinct locations in the plane of the touch panel and to produce distinct signals representative of the location of the touches on the plane of the touch panel for each of the multiple touches. The disclosure teaches both self- and mutual-capacitive touch screens.

Referring to FIG. 10, a prior-art display and touch-screen apparatus 100 includes a display 110 with a corresponding touch screen 120 mounted with the display 110 so that information displayed on the display 110 can be viewed through the touch screen 120. Graphic elements displayed on the display 110 are selected, indicated, or manipulated by touching a corresponding location on the touch screen 120. The touch screen 120 includes a first transparent substrate 122 with first transparent electrodes 130 formed in the x dimension on the first transparent substrate 122 and a second transparent substrate 126 with second transparent electrodes 132 formed in the y dimension facing the x-dimension first transparent electrodes 130 on the second transparent substrate 126. The first and second transparent electrodes 130, 132 form first and second touch pad areas 128, 129. A dielectric layer 124 is located between the first and second transparent substrates 122, 126 and first and second transparent electrodes 130, 132.

In an alternative prior-art design (not shown), the first and second touch pad areas 128, 129 and the first and second transparent electrodes 130, 132 are formed on a common substrate or in a common layer on a common side of the common substrate. Portions of the second transparent electrodes 132 pass over portions of the first transparent electrode 130 to avoid electrical shorts between the first and second transparent electrodes 130, 132. In this embodiment, there is no separate dielectric layer 124.

In either case, referring also to the plan view of FIG. 11, first touch pad areas 128 of the first transparent electrodes 130 are located adjacent to second touch pad areas 129 of the second transparent electrodes 132. The first and second transparent electrodes 130, 132 have a variable width and extend in orthogonal directions (for example as shown in U.S. Patent Application Publication Nos. 2011/0289771 and 2011/0099805). Electrically connecting wires 114 electrically connect neighboring second touch pad areas 129. If the first and second transparent electrodes 130, 132 are formed in different layers, electrically connecting bridge wires 112 pass over the electrically connecting wires 114 and avoid shorts between the first and second transparent electrodes 130, 132. If the first and second transparent electrodes 130, 132 are formed in a common layer, electrically connecting bridge wires 112 electrically connect neighboring first touch pad areas 128 as shown in the cross sectional inset of FIG. 11.

When a voltage is applied across the first and second transparent electrodes 130, 132, electric fields are formed between the first touch pad areas 128 of the x-dimension first transparent electrodes 130 and the second touch pad areas 129 of the y-dimension second transparent electrodes 132. The electrical current, charge, or capacitance related to the electric fields is measured when no touch is present and compared to similar measurements taken when a touch is present. A difference in the measurements indicates a touch.

It is known in the prior art that, for example, the capacitance between the first and second transparent electrodes 130, 132 is reduced when a touch is present. As the touch implement (e.g. a finger), comes closer to the first and second transparent electrodes 130, 132, the capacitance becomes smaller. However, when the touch implement approaches closer still, the capacitance, instead of continuing to decrease, begins to increase. This capacitance increase is known as false release. To avoid such a false signal, designers employ a cover over the touch screen that is at least as thick as the distance from the first and second transparent electrodes 130, 132 at which a false release would otherwise be detected. Thus, false release cannot be experienced because the cover prevents a touch implement from coming close enough to the first and second transparent electrodes 130, 132 to experience false release. A typical cover distance for touch screens is 700 microns although thinner covers having a thickness of 500 microns are proposed.

Transparent electrodes including very fine patterns of conductive elements, such as metal wires or conductive traces are known. For example, U.S. Patent Application Publication No. 2011/0007011 teaches a capacitive touch screen with a mesh electrode, as do U.S. Patent Application Publication No. 2010/0026664, U.S. Patent Application Publication No. 2010/0328248, and U.S. Pat. No. 8,179,381, which are hereby incorporated in their entirety by reference. As disclosed in U.S. Pat. No. 8,179,381, fine conductor patterns are made by one of several processes, including laser-cured masking, inkjet printing, gravure printing, micro-replication, and micro-contact printing. In particular, micro-replication is used to form micro-conductors formed in micro-replicated channels. The transparent micro-wire electrodes include micro-wires between 0.5μ and 4μ, wide and a transparency of between approximately 86% and 96%.

Conductive micro-wires are formed in micro-channels embossed in a substrate, for example as taught in CN102063951, which is hereby incorporated by reference in its entirety. As discussed in CN102063951, a pattern of micro-channels are formed in a substrate using an embossing technique. Embossing methods are generally known in the prior art and typically include coating a curable liquid, such as a polymer, onto a rigid substrate. A pattern of micro-channels is embossed (impressed or imprinted) onto the polymer layer by a master having an inverted pattern of structures formed on its surface. The polymer is then cured. A conductive ink is coated over the substrate and into the micro-channels, the excess conductive ink between micro-channels is removed, for example by mechanical buffing, patterned chemical electrolysis, or patterned chemical corrosion. The conductive ink in the micro-channels is cured, for example by heating. In an alternative method described in CN102063951, a photosensitive layer, chemical plating, or sputtering is used to pattern conductors, for example using patterned radiation exposure or physical masks. Unwanted material (such as photosensitive resist) is removed, followed by electro-deposition of metallic ions in a bath.

Capacitive touch screen devices are constructed by locating micro-wire electrodes on either side of a dielectric layer. Referring to FIG. 12, a prior-art display and touch-screen apparatus 100 includes the display 110 with the corresponding touch screen 120 mounted with the display 110 so that information displayed on the display 110 can be viewed through the touch screen 120. Graphic elements displayed on the display 110 are selected, indicated, or manipulated by touching a corresponding location on the touch screen 120. The touch screen 120 includes the first transparent substrate 122 with first transparent electrodes 130 formed in the x dimension on the first transparent substrate 122 and the second transparent substrate 126 with second transparent electrodes 132 formed in the y dimension facing the x-dimension first transparent electrodes 130 on the second transparent substrate 126. The dielectric layer 124 is located between the first and second transparent substrates 122, 126 and first and second transparent electrodes 130, 132. Common first and second touch pad areas 128, 129 are formed by the overlap of the first transparent electrodes 130 and the second transparent electrodes 132. When a voltage is applied across the first and second transparent electrodes 130, 132, electric fields are formed between that are measurable to detect changes in capacitance due to the presence of a touch element, such as a finger or stylus.

In the designs illustrated in both FIG. 10 and FIG. 12, a display controller 142 connected through electrical buss connections 136 controls the display 110 in cooperation with a touch-screen controller 140. The touch-screen controller 140 is connected through electrical buss connections 136 and wires 134 and controls the touch screen 120. The touch-screen controller 140 detects touches on the touch screen 120 by sequentially electrically energizing and testing the x-dimension first and y-dimension second transparent electrodes 130, 132.

Referring to FIG. 13, a prior-art x- or y-dimension first or second variable-width transparent electrode 130, 132 includes a micro-pattern 156 of micro-wires 150 arranged in a rectangular grid. The micro-wires 150 are multiple very thin metal conductive traces or wires formed on the first and second transparent substrates 122, 126 to form the x- or y-dimension first or second transparent electrodes 130, 132. The micro-wires 150 are so thin that they are not readily visible to a human observer, for example 1 to 10 microns wide. The micro-wires 150 are typically opaque and spaced apart, for example by 50 to 500 microns, so that the first or second transparent electrodes 130, 132 appear to be transparent and the micro-wires 150 are not distinguished by an observer.

Referring to FIG. 14, in another prior-art embodiment illustrated in U.S. Patent Application Publication No. 2011/0291966, the rectangular first and second transparent electrodes 130, 132 that include micro-wires 150 are arranged orthogonally in a micro-pattern 156 on first and second transparent substrates 122, 126 with intervening dielectric layer 124, forming touch screen 120 which, in combination with the display 110 forms the touch screen 120 and display apparatus 100 (FIG. 12). The micro-pattern 156 of the micro-wires 150 in the first transparent electrodes 130 is orthogonal with respect to the micro-pattern 156 of the micro-wires 150 in the second transparent electrodes 132.

Sensitivity, efficiency, size, and weight are important attributes for touch screens. It is important to reliably detect touches without false positive or false negative signals and to do so using as little power as possible. Since many touch screens are employed in mobile electronic devices, it is also important to reduce the size, in particular the thickness and the weight of touch screens so that the mobile electronic devices cost less are easier to carry.

### SUMMARY OF THE INVENTION

There is a need, therefore, for further improvements in the structure of a touch-screen device that improves sensitivity and efficiency and reduces thickness and weight.

In accordance with the present invention, a micro-wire touch-screen device that does not experience false release comprises:

a transparent layer having a surface;

a plurality of drive electrodes formed in relation to the transparent layer, each drive electrode including a plurality of electrically connected drive micro-wires;

a plurality of sense electrodes formed in relation to the transparent layer, each sense electrode including a plurality of electrically connected sense micro-wires, the sense micro-wires isolated from the drive micro-wires;

the transparent layer disposed such that the location of the transparent layer surface is selected to be greater than zero and less than 500 microns from the sense electrodes in a direction perpendicular to the transparent layer surface; and

whereby the drive electrodes and the sense electrodes form a capacitive touch sensor that does not experience false release.

The present invention provides a touch-screen device with reduced thickness and weight while reducing unwanted false signals. The use of sense micro-wires located between drive micro-wires in micro-wire electrodes together with thinner covers prevents the occurrence of false release and reduces device thickness and weight.

### BRIEF DESCRIPTION OF THE DRAWINGS

The above and other features and advantages of the present invention will become more apparent when taken in conjunction with the following description and drawings wherein identical reference numerals have been used to designate identical features that are common to the figures, and wherein:

FIG. 1 is a cross section of an embodiment of the present invention taken along the cross section line A of FIG. 3 at a different magnification and scale, for clarity;

FIG. 2 is a plan view of an embodiment of the present invention;

FIG. 3 is a plan view of interleaved micro-wire electrodes useful in understanding the present invention;

FIG. 4 is a plan view of interleaved micro-wire electrodes useful in understanding the present invention;

FIG. 5 is a cross section of an alternative embodiment of the present invention;

FIG. 6A is a graph illustrating charge at different distances from the sense electrode useful in understanding the present invention;

FIG. 6B is a graph illustrating charge at different distances from the sense electrode with a cover layer having a dielectric constant of 3 useful in understanding the present invention;

FIG. 7A is a table providing values for cover thickness and detection sensitivity for 2.5 micron wires useful in understanding the present invention;

FIG. 7B is a table providing values for cover thickness and detection sensitivity for 5.5 micron wires useful in understanding the present invention;

FIG. 8 is a flow chart describing a method useful in making an embodiment of the present invention;

FIG. 9 is a flow chart describing a method useful in making an embodiment of the present invention;

FIG. 10 is an exploded perspective illustrating a prior-art mutual capacitive touch screen having adjacent pad areas in conjunction with a display and controllers;

FIG. 11 is a schematic illustrating prior-art adjacent pad areas in a capacitive touch screen;

FIG. 12 is an exploded perspective illustrating a prior-art mutual capacitive touch screen having overlapping pad areas in conjunction with a display and controllers;

FIG. 13 is a schematic illustrating prior-art micro-wires in an apparently transparent electrode; and

FIG. 14 is a schematic illustrating prior-art micro-wires arranged in two arrays of orthogonal transparent electrodes.

The Figures are not drawn to scale since the variation in size of various elements in the Figures is too great to permit depiction to scale.

### DETAILED DESCRIPTION OF THE INVENTION

The present invention provides a micro-wire touch-screen device useful in combination with a display that reduces thickness and weight while also reducing unwanted false touch signals that does not experience false release.

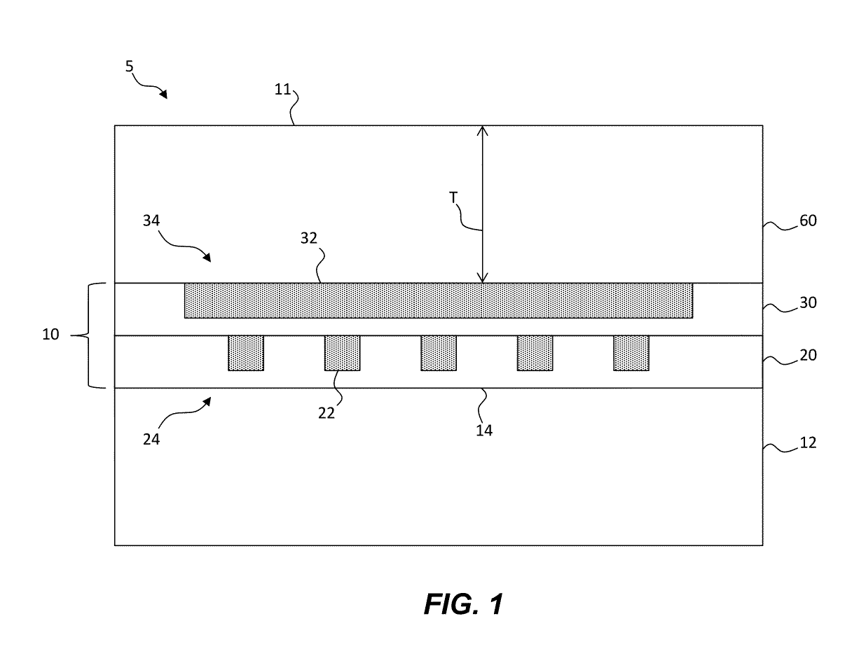

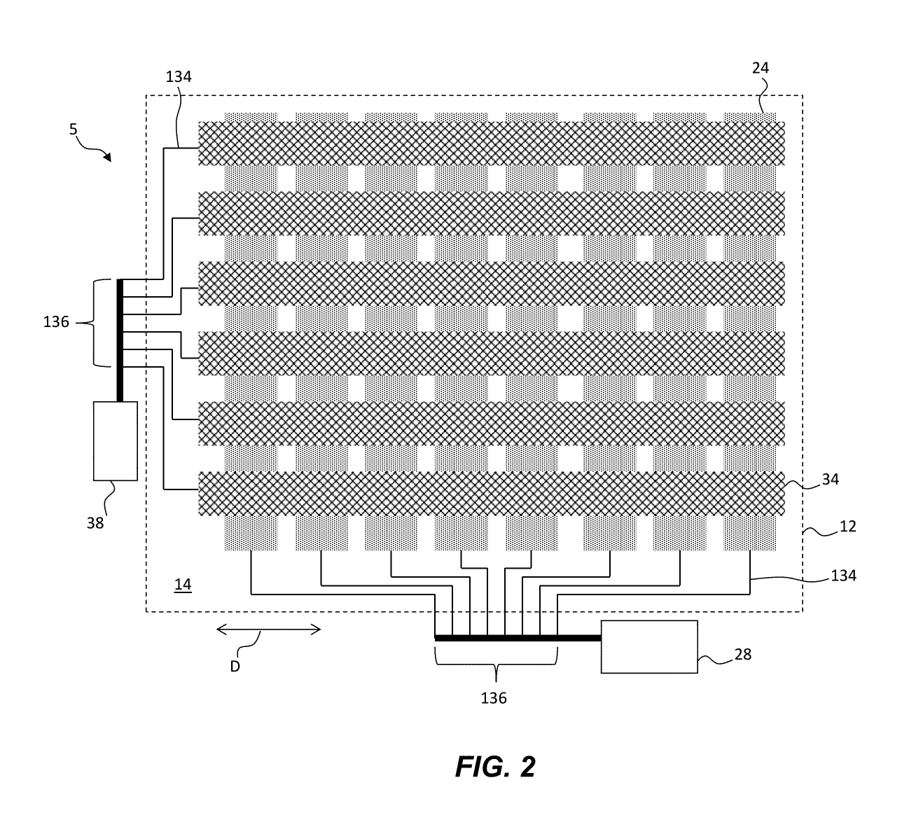

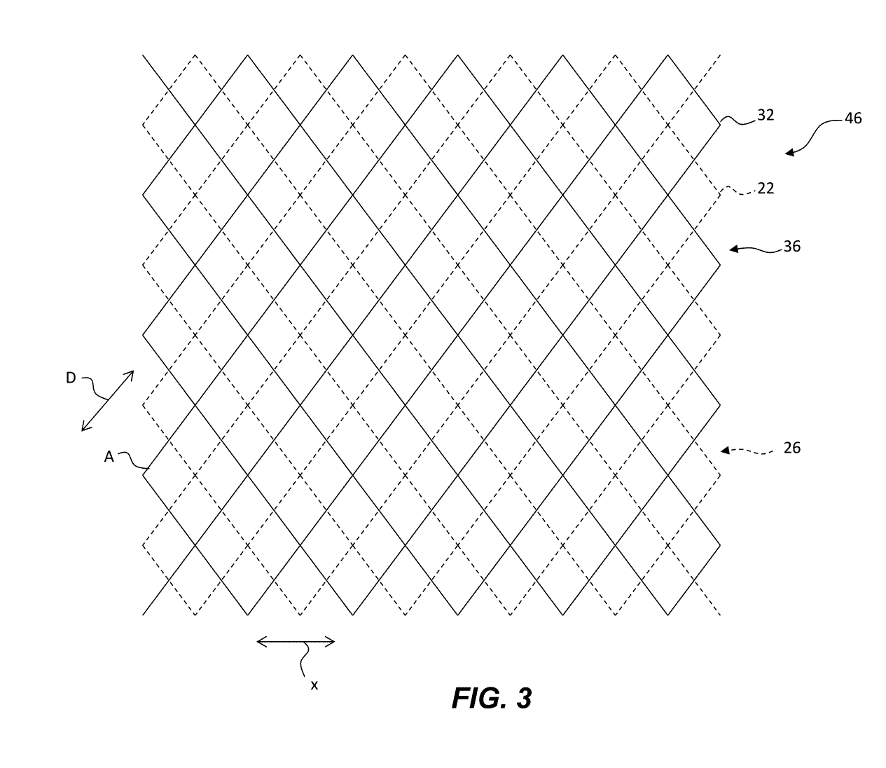

Referring to FIG. 1 in cross section, to the plan view of FIG. 2, and to the detail of FIG. 3, a touch-screen device 5 in an embodiment of the present invention includes a transparent layer having a surface. In the embodiment of FIG. 1, the transparent layer is a cover 60 with a touch-screen surface 11. In an alternative embodiment, the transparent layer is a substrate 12 with a substrate surface 14. In the first case, touches are detected on the touch-screen surface 11. In the second case touches are detected on the substrate surface 14. For clarity, the transparent layer is generally illustrated as the cover 60 in the Figures, but the present invention also includes an embodiment in which the transparent layer is the substrate 12.

A plurality of drive electrodes 24 are formed in relation to the transparent layer, for example on substrate surface 14 of the substrate 12 and spaced apart from the touch-screen surface 11. Each drive electrode 24 includes a plurality of electrically connected drive micro-wires 22. A plurality of sense electrodes 34 are also formed in relation to the substrate 12. Each sense electrode 34 includes a plurality of electrically connected sense micro-wires 32. The transparent layer (e.g. cover 60 or substrate 12) is disposed such that the location of the transparent layer surface (e.g. touch-screen surface 11 or substrate surface 14) is selected to be greater than zero and less than 500 microns from the sense electrodes 34 in a direction perpendicular to the transparent layer surface. The sense electrodes 34 and the sense micro-wires 32 are electrically isolated from the drive electrodes 24 and the drive micro-wires 22, so that the drive electrodes 24, the sense electrodes 34, and the transparent layer form a capacitive touch sensor that does not experience false release.

Generally, the cover 60 protects the drive and sense micro-wires 22, 32 and the drive and sense micro-wires 22, 32 are formed in, on, or over the substrate surface 14 of the substrate 12. As will be understood by those familiar with touch screen technology, the relative position of the cover 60 and substrate 12 can be exchanged and the drive and sense micro-wires 22, 32 can be considered to be either over or under the substrate 12.

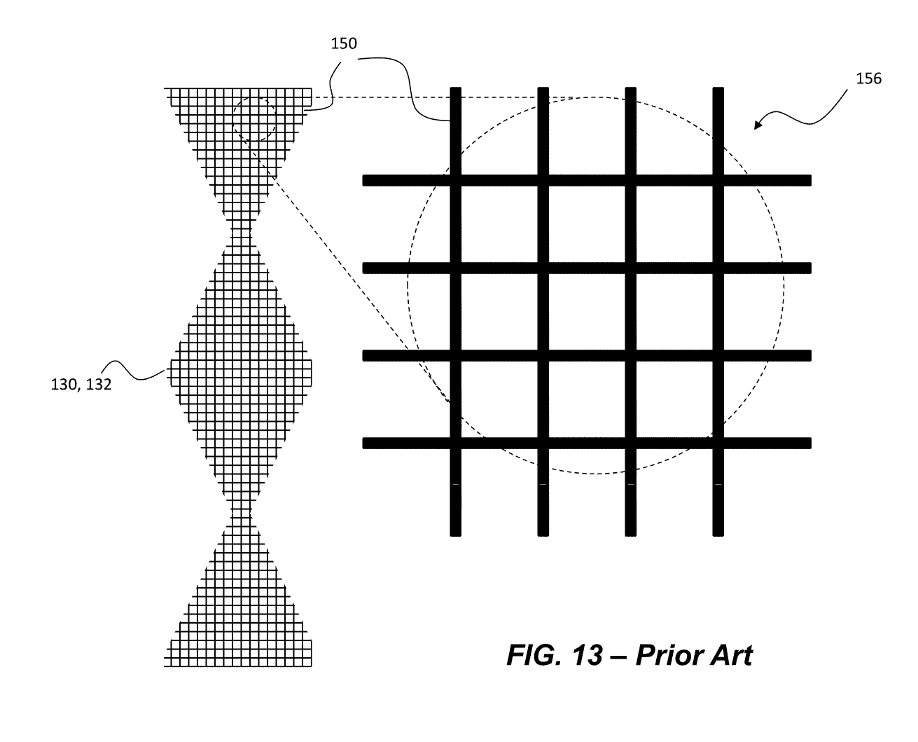

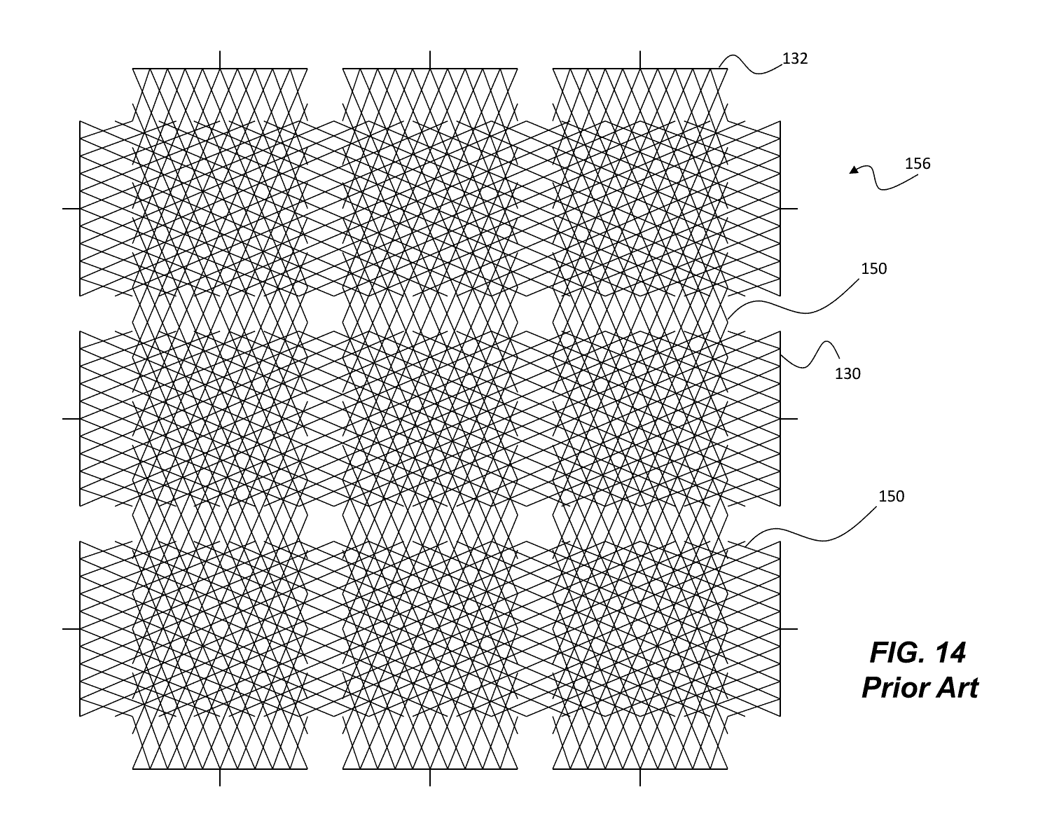

As shown in FIG. 3, in an embodiment the sense micro-wires 32 formed in a sense micro-wire pattern 36 are located between the drive micro-wires 22 formed in a drive micro-wire pattern 26 in a direction D parallel to the substrate surface 14 (FIG. 1). In an embodiment, both the sense and drive micro-wire patterns 36, 26 are the same micro-wire pattern, for example the illustrated diamond pattern. In this arrangement, the sense and drive micro-wire patterns 36, 26 are not rotated with respect to each other and are spatially out of phase in one dimension, for example 180 degrees spatially out of phase in the x dimension as shown. Thus, the sense micro-wires 32 are interleaved or interdigitated between the drive micro-wires 22 and alternate in the direction D when viewed in a plan view of the substrate 12. Alternatively, the sense and drive micro-wire patterns 36, 26 are different. In another embodiment, the sense and drive micro-wire patterns 36, 26 form grids with the sense and drive micro-wires 32, 22 interleaved in a grid pattern having orthogonal rows and columns of micro-wires (not shown, FIG. 13 illustrates a grid arrangement of micro-wires).

FIG. 3 illustrates an embodiment in which sense micro-wires 32 are located between adjacent drive micro-wires 22 in a direction D parallel to the substrate surface 14. Adjacent drive micro-wires 22 are pairs of drive micro-wires 22 between which there is no other drive micro-wire 22. In another embodiment, the spatial frequency of the drive micro-wires 22 in the drive electrodes 24 is different from the spatial frequency of the sense micro-wires 32 in the sense electrodes 34 and the sense micro-wire 32 is not necessarily located between each pair of adjacent drive micro-wires 22.

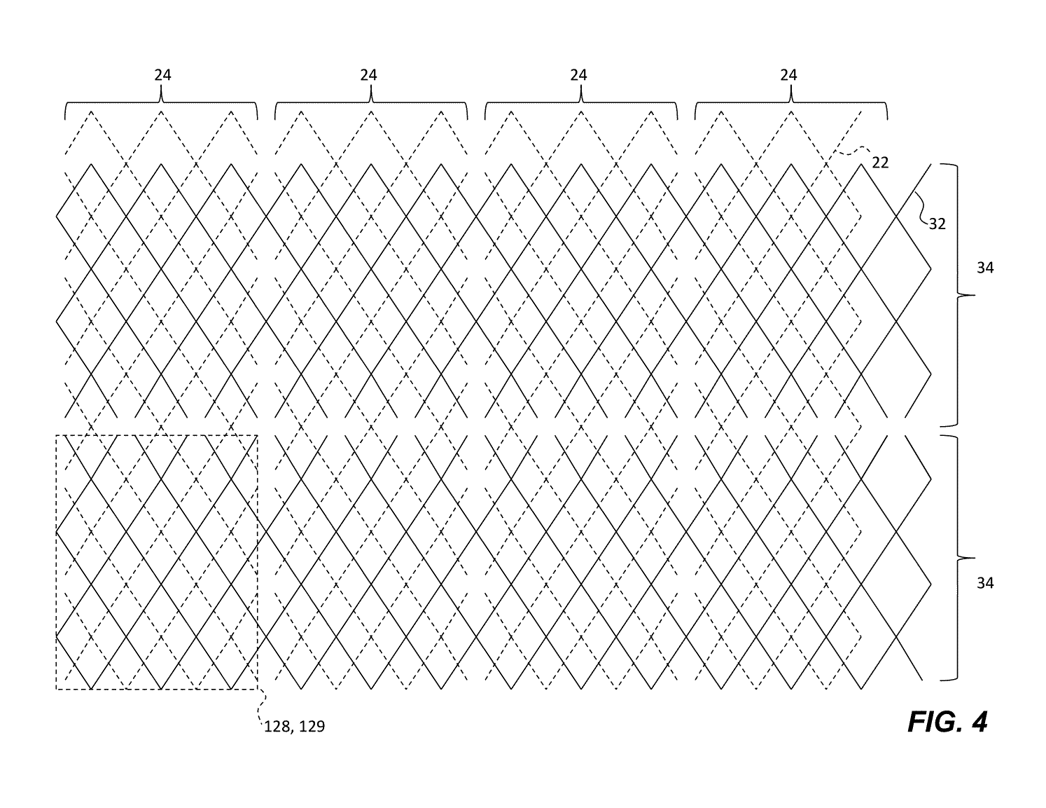

FIG. 4 illustrates an array of drive electrodes 24 arranged orthogonally to an array of sense electrodes 34. The drive micro-wires 22 making up the drive electrodes 24 are arranged in a diamond drive micro-wire pattern 26. Similarly, the sense micro-wires 32 making up the sense electrodes 34 are arranged in the same diamond pattern but the sense micro-wire pattern 36 is 180 degrees spatially out of phase with respect to the drive micro-wire pattern 26 in one dimension. The drive micro-wires 22 in each drive electrode 24 are electrically connected but the drive micro-wires 22 in any drive electrode 24 are electrically isolated from the drive micro-wires 22 in any other drive electrode 24 or the sense micro-wires 32 in any sense electrode 34. Thus, the drive electrodes 24 are electrically isolated from each other and from the sense electrodes 34. Similarly, the sense micro-wires 32 in each sense electrode 34 are electrically connected but the sense micro-wires 32 in any sense electrode 34 are electrically isolated from the sense micro-wires 32 in any other sense electrode 34 or any drive electrode 24. Thus, the sense electrodes 34 are electrically isolated from each other and from the drive electrodes 24.

Electrical isolation for the drive and sense electrodes 24, 34 is provided by forming gaps, or breaks in the drive or sense micro-wires 22, 32 forming the drive or sense micro-wire patterns 26, 36. Regions of the substrate 12 where each drive electrode 24 overlaps with the sense electrode 34 form common first and second touch pad areas 128, 129. Each of these common first and second touch pad areas 128, 129 forms a capacitor whose charge, current, or capacitance is measured using methods known in the art. Note that although the drive and sense electrodes 24, 34 overlap, the individual drive and sense micro-wires 22, 32 in the drive and sense electrodes 24, 34 are interleaved and do not directly overlap except where one crosses over the other. In an alternative embodiment, the individual drive and sense micro-wires 22, 32 form spatially in-phase drive and sense micro-wire patterns 26, 36 so that the drive and sense micro-wires 22, 32 do overlap.

The drive or sense micro-wires 22, 32 in each of either the drive or sense electrodes 24, 34 respectively are illustrated as having the same micro-pattern. Indeed, the drive micro-wires 22 in the drive electrodes 24 are aligned to form the drive micro-wire pattern 26 that has consistently aligned drive micro-wires from drive electrode 24 to drive electrode 24. Similarly, the sense micro-wires 32 in the sense electrodes 34 are aligned to form the sense micro-wire pattern 36 that is consistently aligned from sense electrode 34 to sense electrode 34. In another embodiment, the micro-wire patterns of two or more drive or sense electrodes 24, 34 are not aligned or are different.

Referring back to FIG. 1, the cover 60 is located on a side of the drive and sense electrodes 24, 34 opposite the substrate 12, the cover 60 having a thickness T of less than 500 microns. As shown in FIG. 2, wires 134 are electrically connected to the drive micro-wires 22 of each drive electrode 24 to form electrical buss connections 136 that are connected to a drive circuit 28. Wires 134 are also electrically connected to the sense micro-wires 32 of each sense electrode 34 to form electrical buss connections 136 that are connected to a sense circuit 38. The drive circuit 28 supplies electrical energy to energize the drive micro-wires 32 in the drive electrodes 34 and the sense circuit 38 is electrically connected to the sense micro-wires 32 to sense charge, capacitance, or current in the sense micro-wires 32. According to an embodiment of the present invention, the drive electrodes 24, the sense electrodes 34, and the cover 60 form the capacitive touch-screen device 5 that does not experience false release when touched.

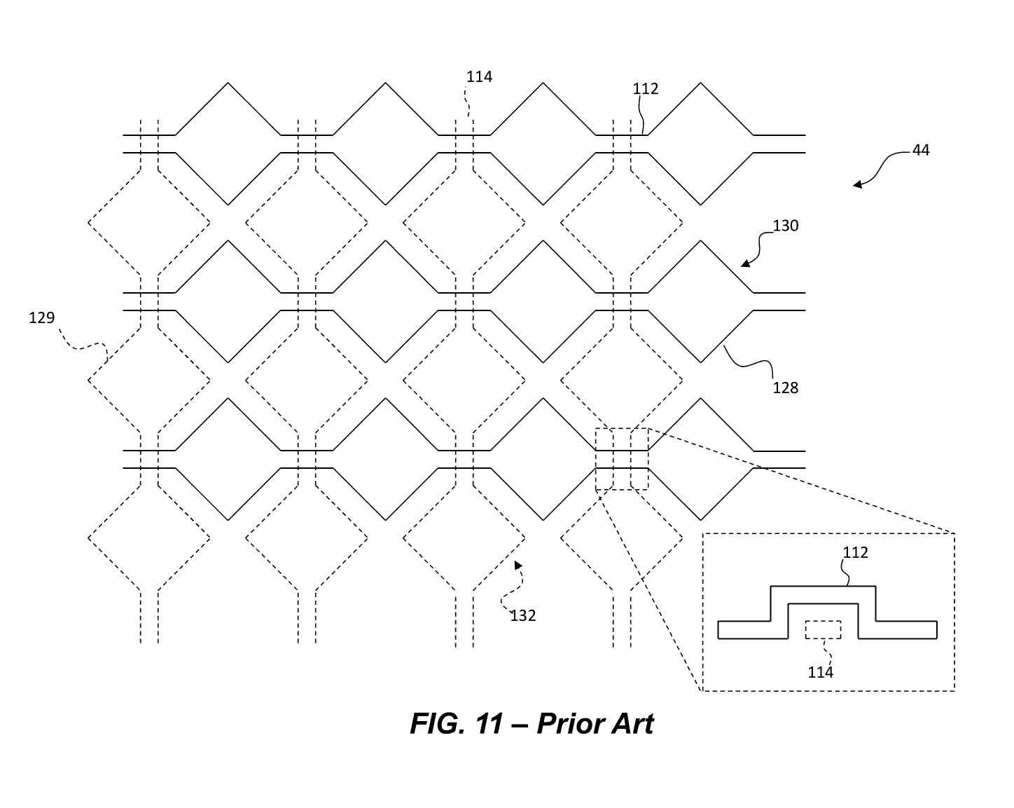

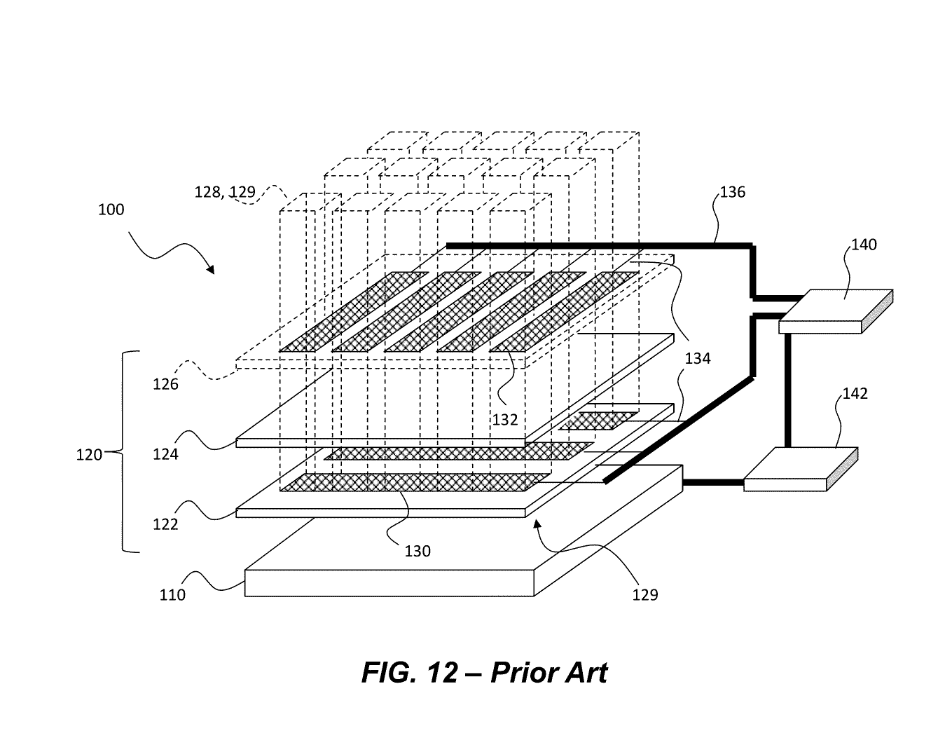

In an embodiment, the drive micro-wires 22 of the drive electrodes 24 and the sense micro-wires 32 of the sense electrodes 34 are formed in separate layers, as illustrated in FIG. 1. In yet another embodiment, the drive micro-wires 22 of the drive electrodes 24 are formed in a common layer with the sense micro-wires 32 of the sense electrodes 34, combining the drive and sense layers 20, 30 in one common layer. In such an embodiment, the drive electrodes 24 are electrically isolated from the sense electrode with, for example, electrically connecting bridges 112 that extend over the electrically connecting wires 114 (as illustrated in the inset of FIG. 11) to avoid shorts between the drive and sense micro-wires 22, 32.

In another embodiment, the drive electrodes 24 are located between the sense electrodes 34 and the substrate surface 14 (as illustrated in FIG. 1) so that the sense electrodes 34 are formed in a sense layer and the drive electrodes 24 are formed in a drive layer between the transparent layer and the sense layer. Alternatively, the sense electrodes 34 are located between the drive electrodes 24 and the substrate surface 14 so that the drive electrodes 24 are formed in a drive layer and the sense electrodes 34 are formed in a sense layer between the transparent layer and the drive layer (not shown).

In one embodiment, the drive micro-wires 22 of the drive electrodes 24 are formed in a drive layer 20 on the substrate surface 14 (as shown in FIG. 1). Alternatively, the drive micro-wires 22 of the drive electrodes 24 are formed in the drive layer 20 over or under the substrate surface 14 (not shown). In other embodiments, the drive micro-wires 22 of the drive electrodes 24 are formed in the substrate 12 or directly on the substrate surface 14. Similarly, in one embodiment, the sense micro-wires 32 of the sense electrodes 34 are formed in a sense layer 30 on the drive layer 20 (as shown in FIG. 1). Alternatively, the sense micro-wires 32 of the sense electrodes 34 are formed in the sense layer 30 on, over, or under the substrate surface 14 (not shown). In other embodiments, the sense micro-wires 32 of the sense electrodes 24 are formed in the substrate 12 or directly on the substrate surface 14. The drive micro-wires 22 forming the drive electrodes 24 in the drive layer 20 and the sense micro-wires 32 forming the sense electrodes 34 in the sense layer 30 together form a touch screen 10.

In an embodiment, the substrate 12 is the cover, substrate, or other component of a display. In an embodiment, the substrate 12 or cover 60 includes glass; in another embodiment, the substrate 12 or cover 60 includes polymer. In an embodiment, the substrate 12, the cover 60, the sense layer 30, or the drive layer 20 is an apparently transparent layer. By transparent is meant that the substrate 12, the cover 60, the sense layer 30, or the drive layer 20 is at least 50%, 70%, 80%, 90%, 95%, or 98% transparent to visible light. Although the sense and drive micro-wires 32, 22 of the present invention are not necessarily transparent, in useful embodiments the sense and drive micro-wires 32, 22 are sufficiently spaced apart that most visible light passes through the sense layer 30 and the drive layer 20, permitting a user of the touch-screen device to see through the sense layer 30 and the drive layer 20 and view an underlying display without apparent visual obstruction. Moreover, in other useful embodiments, the sense and drive micro-wires 32, 22 are very narrow (for example less than 10 microns, less than 5 microns, less than 4 microns, or less than 2 microns wide), so that they are not readily perceived by the human visual system and therefore rendering the sense layer 30 and the drive layer 20 apparently transparent.

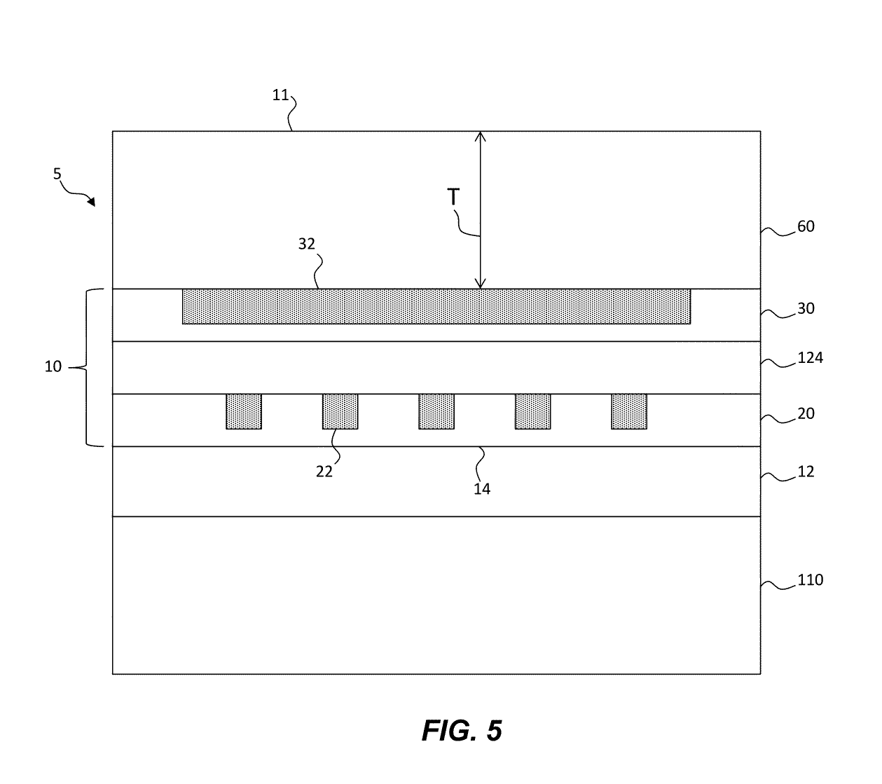

Referring to FIG. 5, in another embodiment the touch screen 10 of the touch-screen device 5 includes the separate dielectric layer 124 located between the sense layer 30 having sense micro-wires 32 and the drive layer 20 having drive micro-wires 22. As is also shown in FIG. 5, the substrate 12 is located on the display 110. The cover 60 located on the sense layer 20 has a thickness T less than 500 microns.

As shown in FIGS. 1 and 5, the cover 60 has a surface opposite the sense layer 30 that serves as the touch-screen surface 11. In an embodiment, the thickness T refers to the distance from the touch-screen surface 11 to the sense micro-wires 32 of the sense electrode 34 or the drive micro-wires 22 of the drive electrodes 24, whichever are closer. As intended herein, the cover 60 can include multiple layers including, for example, adhesive layers, anti-reflection layer, multiple cover layers, or dirt- or scratch-resistant layers. In an embodiment, the cover 60 is in direct contact with the sense layer 30 (as shown) or drive layer 20 (not shown). Alternatively, the cover 60 is separated from the sense or the drive layer 30, 20 by a gap, for example an air gap. In such an embodiment, the distance from the touch-screen surface 11 of the cover 60 to the sense micro-wires 32 of the sense electrode 34 or the drive micro-wires 22 of the drive electrodes 24 is less than 500 microns.

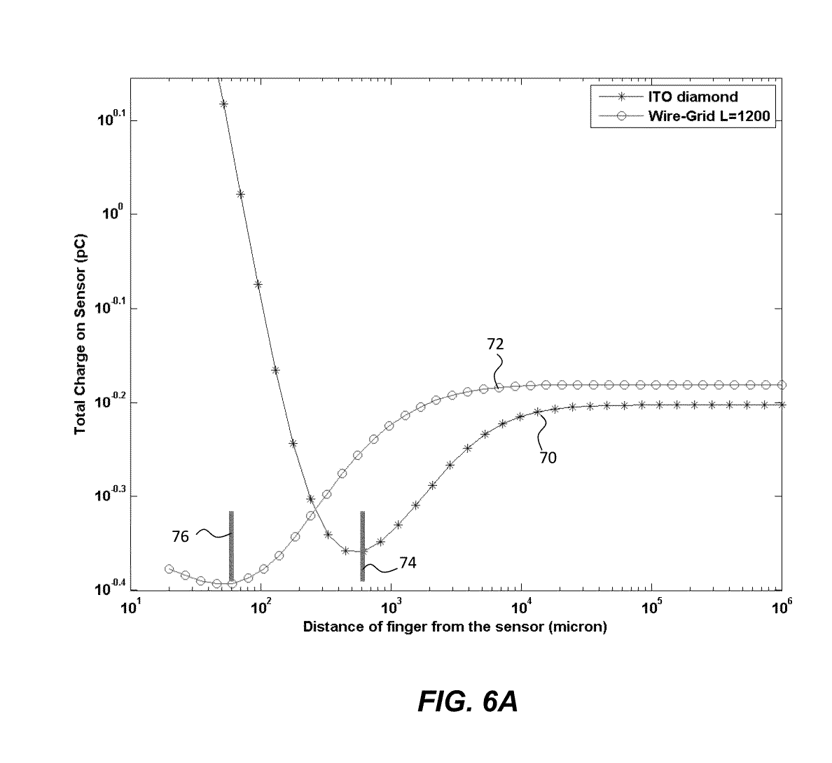

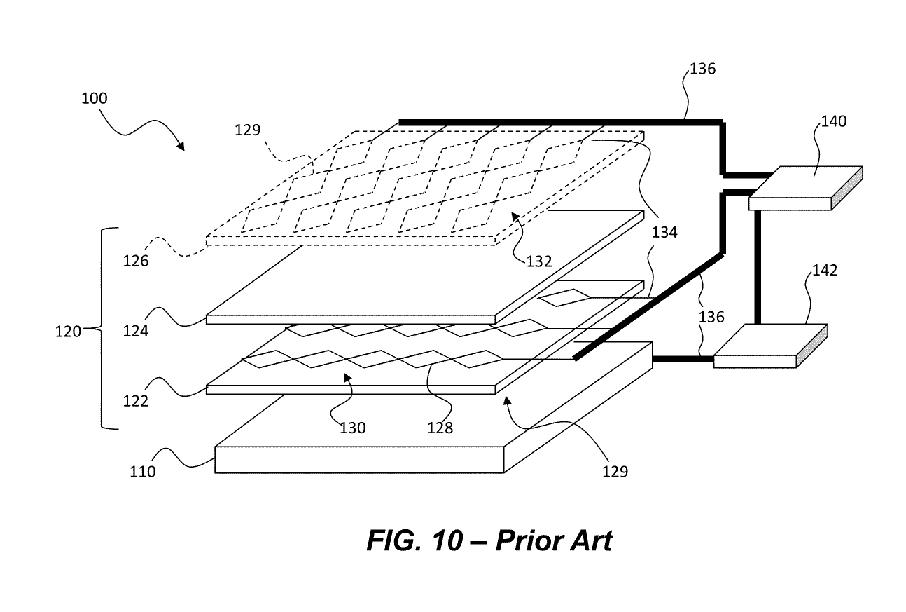

Referring to FIG. 6A, a conventional method-of-moments model of charge behavior based upon equations describing the fundamental physical attributes of charges and fields has been applied to the prior-art structures of FIGS. 10 and 11 and to the inventive structures of FIGS. 1-5. The model consists of equal-potential patterns representing the driver and sensor geometries of these prior-art and inventive structures, respectively. In addition two square, equal-potential surfaces, parallel to the driver and sensor planes were incorporated to represent a floating finger and ground plane, respectively. The distance between the finger and ground plane was selected and fixed to model the strength of the capacitive coupling between a real finger (or stylus) and ground, while the distance of the finger plane was varied from 1 μm to 1 m to determine the expected capacitance of the sensor over a broad range of finger positions. The results for a prior-art diamond pattern example and an embodiment of the inventive wire-grid structure are shown in FIG. 6A. Results are presented on a log-log plot to clearly illustrate the transition points from increasing signal strength to false release. The transition points represent the ideal position for the cover layer surface to give optimum sensitivity for a diamond pattern 44 (FIG. 11), and a wire-grid pattern 46 (FIG. 3), respectively. This model assumed a uniform dielectric constant of 1 everywhere outside the conductive patterns. Further calculations, summarized in FIG. 6B, incorporated a dielectric constant of 3 between the sensor and floating finger. These calculations showed the optimum surface position of the dielectric surface moving away from the sensor as dielectric strength increases (i.e. optimum cover layer thickness had to increase with increasing dielectric constant). In both cases however, the wire-grid pattern 46 continued to exhibit thinner optimum surface thickness relative to a diamond pattern 44 with the same dielectric material. Referring to the semi-log plot in FIG. 6B for a dielectric constant equal to 3, the optimum thickness for the cover on the wire-grid pattern 46 was about 160 μm while the optimum for diamond pattern 44 was about 800 μm. Furthermore, a model that incorporate a cover having a dielectric constant of 3 and a thickness equal to the distance at which maximum sensitivity is obtained together with a dielectric constant of 1 (air) for the remaining distance between the finger and the cover results in a position of maximum sensitivity that is the same position of maximum sensitivity as that illustrated in FIG. 6B.

As shown in FIGS. 6A and 6B, the model illustrates the false-release phenomenon found in the prior art. A prior-art charge curve 70 demonstrates that prior-art devices experience a charge minimum 74 between 500 and 700 microns from the sensor (FIG. 6A) or between 600 and 800 microns from the sensor (FIG. 6B). Hence, prior-art capacitive touch screens include a cover having a thickness greater than 500 microns that prevents touches from approaching the sensor closer than 500 microns so that false release cannot physically occur. A typical cover has a thickness of 700 microns, 1.1 mm, or more and a dielectric constant of approximately 3.

Unexpectedly and surprisingly, it has been found that this limitation is different for capacitive touch screens using the interleaved micro-wire sense and drive electrodes 34, 24 of the present invention. As shown in FIGS. 6A and 6B, the charge minimum 76 for inventive charge curve 72 is at approximately 60 microns, about one tenth of the distance seen in prior-art designs, (FIG. 6A) or at approximately 160 microns (FIG. 6B). Hence, according to an embodiment of the present invention, a mutual-capacitive touch screen using interleaved micro-wires includes a cover having a thickness less than 500 microns. It was expected that, because mutual-capacitive touch screens employ the same physical principles to form capacitors and to detect changes in capacitance (indeed, it has been demonstrated that the same controlling electronic circuits are useful with touch screens of the present invention as with prior-art controllers), similar limitations in performance would exist. However, unexpectedly and surprisingly, it has been found that this is not necessarily the case.

Experiments have been conducted for both the prior-art designs of FIGS. 10 and 11 and the invention of FIGS. 1-5. False release has been demonstrated at the distances modeled in FIGS. 6A and 6B for the prior-art designs, while for the invention of FIGS. 1-5 no false release has been detected. Thus, in further embodiments of the present invention, the cover is less than or equal to 400 microns thick, less than or equal to 250 microns thick, less than or equal to 100 microns thick, or less than or equal to 50 microns thick. A thinner cover enables more portable devices and reduced weight and cost. In embodiments in which greater mechanical rigidity is required, the substrate 12 is thicker or is an element of another component, such as a display, that provides the needed mechanical strength.

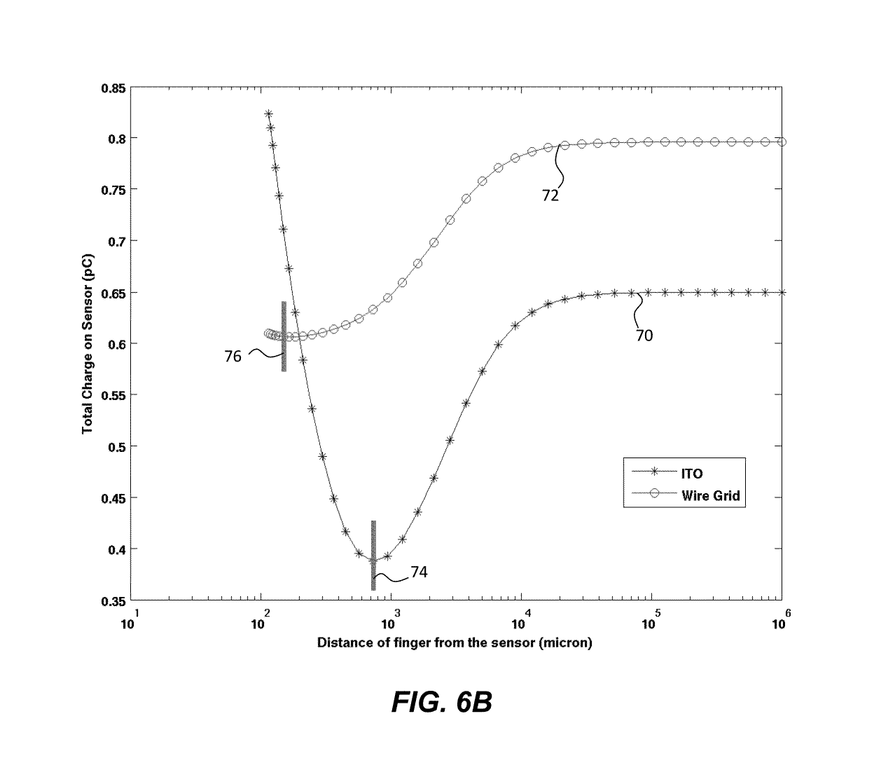

Referring to FIGS. 7A and 7B, various arrangements of the sense and drive micro-wire patterns 36, 26 have been modeled. As shown in FIG. 7A, for a 2.5 micron-wide micro-wire, cell sizes of 400 to 1600 microns result in charge minimums of less than 20 microns to 45 microns. The cell size corresponds to the pitch of the micro-wires in a direction and the cover thickness corresponds to the charge minimum. Moreover, as the cell size decreases the % relative sensitivity (the difference between the charge at a large distance and the charge minimum divided by the charge at the large distance) decreases while the absolute sensitivity (total charge at the charge minimum or large distance) increases. Thus, in some embodiments, the signal-to-noise ratio is improved over the prior art. Similar results are found for 5.5 micron-wide micro-wires; in this case the charge minimums are about 50% larger, the relative sensitivity somewhat smaller and the absolute sensitivity somewhat larger.

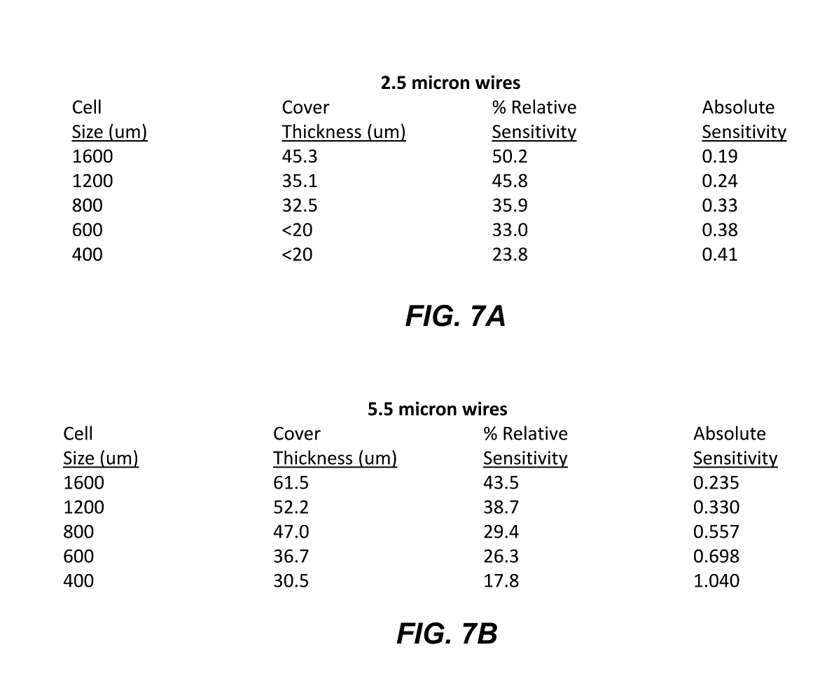

In various embodiments, a corresponding variety of methods are useful in constructing various embodiments of the present invention. Referring to the method of FIG. 8, the substrate 12 is provided in step 200. The substrate 12 can include glass or polymer. The construction of glass substrates 12 is known in the art as are plastic substrates 12, for example made of polycarbonate. The substrate 12 can be an element of the display 110.

Drive electrodes 24 including drive micro-wires 22 are formed in step 205 in relation to the substrate 12. Sense electrodes 34 including sense micro-wires 32 are formed in step 210 in relation to the substrate 12. In step 215, the cover 60 is provided. In an embodiment, the drive electrodes 24 are formed in the drive layer 20 on the substrate 12 and the sense electrodes 34 are formed in the sense layer 30 on the drive layer 20, as shown in FIG. 1. The cover 60 is applied to the sense layer 30, for example with an optically matched adhesive (for example a transparent adhesive having a refractive index matched to that of the cover 60). Alternatively, cover 60 is coated on sense layer 20. Suitable covers 60 made of glass or polymer are known in the art, as are lamination and coating methods. The drive layer 20 can be coated or laminated on the substrate 12 and the sense layer 30 can be coated or laminated on the drive layer 20, or vice versa. In various embodiments, the dielectric layer 124, if employed, is provided using various prior-art methods such as laminating or coating, for example by sputtering, evaporating, or hopper coating.

In one embodiment, the drive and sense micro-wires 22, 32 are printed or otherwise transferred from a printing surface onto the drive or sense layers 20, 30, or directly onto the substrate 12 (with additional coatings and structures to prevent electrical shorts between drive and sense micro-wires 22, 32 as shown in the inset of FIG. 11). In an embodiment, the drive or sense micro-wires 22, 32 are formed by coating a flexographic printing substrate having a raised pattern corresponding to a desired micro-wire pattern with a conductive ink. The flexographic substrate is brought into contact with a layer surface to print the conductive ink onto the layer surface. In an optional step, the conductive ink is dried. Flexographic printing substrates are known in the flexographic printing arts.

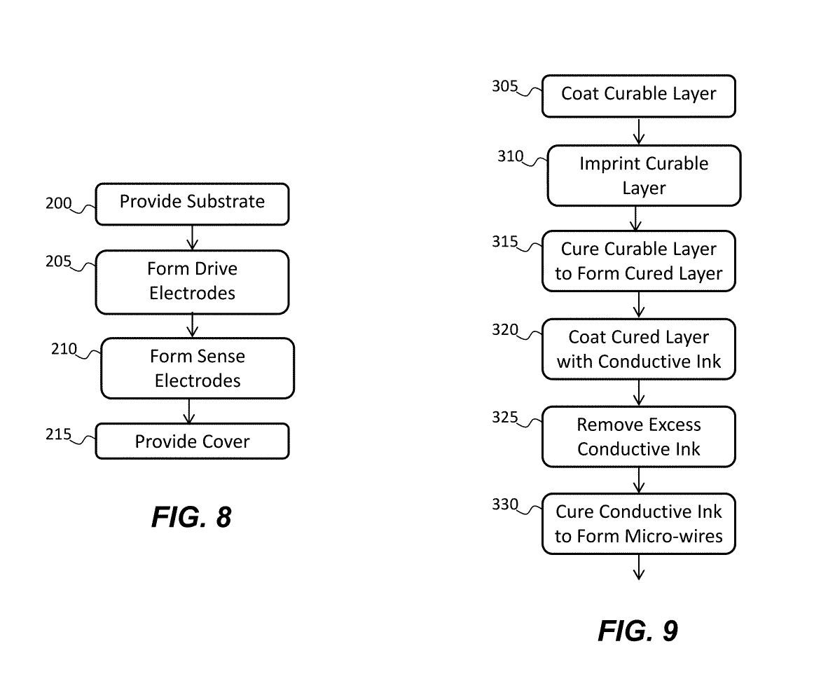

In another embodiment, referring to FIG. 9, the drive layer 20 is provided and the drive electrodes 24 formed, by laminating or coating (step 305) a curable layer that is then imprinted (step 310) with an imprinting stamp and cured (step 315) to form a cured layer having micro-channels therein. The curable layer can be a resin that is cured by cross linking the resin with heat or radiation, for example ultraviolet radiation. The micro-channels are then filled with conductive ink in step 320, excess conductive ink is removed in step 325, and the conductive ink is cured in step 330 to form micro-wires 22 in the cured layer. Likewise, the method of FIG. 9 is used to form the sense layer 30, sense electrodes 34, and sense micro-wires 32.

Micro-wires can also be formed and patterned using known photo-lithographic methods. Such known photo-lithographic technology can include a photo-sensitive material that is optically patterned through a mask to cure the photo-sensitive material and removal of uncured material.

In various embodiments, the various layers can be pre-made and laminated together, for example using optically clear adhesives. The drive and sense layers 20, 30 can include similar or the same materials. The cover 60 can have similar or the same materials as the drive or sense layers 20, 30, or the substrate 12. For example, the drive layer 20 is made as a separate construction (for example as a layer of PET) including drive micro-wires 22 and then laminated with an adhesive to substrate 12. Sense layer 30 is made and similarly laminated. In another embodiment, a layer structure is formed on a temporary substrate with a temporary adhesive on a first side, the layer structure is permanently adhered to the substrate 12 or layer formed on the substrate 12 on a second side, and then the temporary substrate is removed from the first side, for example by peeling.

In an embodiment, the drive layer 20 and the sense layer 30 are formed on opposite sides of the substrate 12, rather than on a common side (not shown). Alternatively, dielectric layer 124 is the substrate 12. The substrate 12 can include multiple layers.

In operation, a touch-screen controller (for example the drive circuit 28 of FIG. 2) energizes one or more selected drive electrodes 24 and senses one or more selected sense electrode 34 (for example using sense circuit 38 of FIG. 2) to detect the capacitance, charge, or current or changes in capacitance, charge, or current of the area overlapped by the selected drive electrodes 24 and selected sense electrode 34. Suitable sensed values of capacitance, charge, or current or changes in such sensed values are recorded as touches in the overlapped area.

According to various embodiments of the present invention, the substrate 12 is any material on which a layer is formed. The substrate 12 is a rigid or a flexible substrate made of, for example, a glass, metal, plastic, or polymer material, can be transparent, and can have opposing substantially parallel and extensive surfaces. Substrates 12 can include a dielectric material useful for capacitive touch screens and can have a wide variety of thicknesses, for example 10 microns, 50 microns, 100 microns, 1 mm, or more. In various embodiments of the present invention, substrates 12 are provided as a separate structure or are coated on another underlying substrate, for example by coating a polymer substrate layer on an underlying glass substrate.

In various embodiments, the substrate 12 is an element of other devices, for example the cover or substrate of the display 110 or a substrate, cover, or dielectric layer of a touch screen. In an embodiment, the substrate 12 of the present invention is large enough for a user to directly interact therewith, for example using an implement such as a stylus or using a finger or hand. Methods are known in the art for providing suitable surfaces on which to coat or otherwise form layers. In a useful embodiment, the substrate 12 is substantially transparent, for example having a transparency of greater than 90%, 80% 70% or 50% in the visible range of electromagnetic radiation.

Electrically conductive micro-wires and methods of the present invention are useful for making electrical conductors and busses for transparent micro-wire electrodes and electrical conductors in general, for example as used in electrical busses. A variety of micro-wire patterns are used and the present invention is not limited to any one pattern. Micro-wires can be spaced apart, form separate electrical conductors, or intersect to form a mesh electrical conductor on, in, or above the substrate 12. Micro-wires can be identical or have different sizes, aspect ratios, or shapes. Micro-wires can be straight or curved.

Imprinted layers useful in the present invention can include a cured polymer material with cross-linking agents that are sensitive to heat or radiation, for example infra-red, visible light, or ultra-violet radiation. The polymer material is a curable material applied in a liquid form that hardens when the cross-linking agents are activated. When a molding device, such as an imprinting stamp having an inverse micro-channel structure is applied to liquid curable material and the cross-linking agents in the curable material are activated, the liquid curable material in the curable layer is hardened into a cured layer. The liquid curable materials can include a surfactant to assist in controlling coating. Materials, tools, and methods are known for embossing coated liquid curable materials to form cured layers.

A cured layer is a layer of curable material that has been cured. For example, a cured layer is formed of a curable material coated or otherwise deposited on a layer surface to form a curable layer and then cured to form the cured layer. The coated curable material is considered herein to be a curable layer before it is cured and cured layer after it is cured. Similarly, a cured electrical conductor is an electrical conductor formed by locating a curable material in a micro-channel and curing the curable material to form a micro-wire in a micro-channel. As used herein, curing refers to changing the properties of a material by processing the material in some fashion, for example by heating, drying, irradiating the material, or exposing the material to a chemical, energetic particles, gases, or liquids.

The curable layer is deposited as a single layer in a single step using coating methods known in the art, such as curtain coating. In an alternative embodiment, the curable layer is deposited as multiple sub-layers using multi-layer deposition methods known in the art, such as multi-layer slot coating, repeated curtain coatings, or multi-layer extrusion coating. In yet another embodiment, the curable layer includes multiple sub-layers formed in different, separate steps, for example with a multi-layer extrusion, curtain coating, or slot coating machine as is known in the coating arts.

Curable inks useful in the present invention are known and can include conductive inks having electrically conductive nano-particles, such as silver nano-particles. In an embodiment, the electrically conductive nano-particles are metallic or have an electrically conductive shell. The electrically conductive nano-particles can be silver, can be a silver alloy, or can include silver. In various embodiments, cured inks can include metal particles, for example nano-particles. The metal particles are sintered to form a metallic electrical conductor. The metal nano-particles are silver or a silver alloy or other metals, such as tin, tantalum, titanium, gold, copper, or aluminum, or alloys thereof. Cured inks can include light-absorbing materials such as carbon black, a dye, or a pigment.

In an embodiment, a curable ink can include conductive nano-particles in a liquid carrier (for example an aqueous solution including surfactants that reduce flocculation of metal particles, humectants, thickeners, adhesives or other active chemicals). The liquid carrier is located in micro-channels and heated or dried to remove liquid carrier or treated with hydrochloric acid, leaving a porous assemblage of conductive particles that are agglomerated or sintered to form a porous electrical conductor in a layer. Thus, in an embodiment, curable inks are processed to change their material compositions, for example conductive particles in a liquid carrier are not electrically conductive but after processing form an assemblage that is electrically conductive.

Curable inks provided in a liquid form are deposited or located in drive or sense micro-channels and cured, for example by heating or exposure to radiation such as infra-red radiation, visible light, or ultra-violet radiation. The curable ink hardens to form the cured ink that makes up drive or sense micro-wires 22, 32. For example, a curable conductive ink with conductive nano-particles are located within the drive or sense micro-channels and cured by heating or sintering to agglomerate or weld the nano-particles together, thereby forming an electrically conductive drive or sense micro-wire 22, 32. Materials, tools, and methods are known for coating liquid curable inks to form micro-wires.

Once deposited, the conductive inks are cured, for example by heating. The curing process drives out the liquid carrier and sinters the metal particles to form a metallic electrical conductor. Conductive inks are known in the art and are commercially available. In any of these cases, conductive inks or other conducting materials are conductive after they are cured and any needed processing completed. Deposited materials are not necessarily electrically conductive before patterning or before curing. As used herein, a conductive ink is a material that is electrically conductive after any final processing is completed and the conductive ink is not necessarily conductive at any other point in the micro-wire formation process.

Micro-wires can be metal, for example silver, gold, aluminum, nickel, tungsten, titanium, tin, or copper or various metal alloys including, for example silver, gold, aluminum, nickel, tungsten, titanium, tin, or copper. Micro-wires can include a thin metal layer composed of highly conductive metals such as gold, silver, copper, or aluminum. Other conductive metals or materials are usable. Alternatively, micro-wires can include cured or sintered metal particles such as nickel, tungsten, silver, gold, titanium, or tin or alloys such as nickel, tungsten, silver, gold, titanium, or tin. Conductive inks are used to form micro-wires with pattern-wise deposition or pattern-wise formation followed by curing steps. Other materials or methods for forming micro-wires, such as curable ink powders including metallic nano-particles, are employed and are included in the present invention.

In various embodiments of the present invention, micro-channels or micro-wires have a width less than or equal to 10 microns, 5 microns, 4 microns, 3 microns, 2 microns, or 1 micron. In an example and non-limiting embodiment of the present invention, each micro-wire is from 10 to 15 microns wide, from 5 to 10 microns wide, or from one micron to 5 microns wide. In some embodiments, micro-wires can fill micro-channels; in other embodiments micro-wires do not fill micro-channels. In an embodiment, the micro-wires are solid; in another embodiment, the micro-wires are porous.

Electrically conductive micro-wires of the present invention are operable by electrically connecting micro-wires through connection pads and electrical connectors to electrical circuits that provide electrical current to micro-wires and can control the electrical behavior of micro-wires. Electrically conductive micro-wires can be located in areas other than display areas, for example in the perimeter of the display area of a touch screen, where the display area is the area through which a user views a display.

Methods and devices for forming and providing substrates and coating substrates are known in the photo-lithographic arts. Likewise, tools for laying out electrodes, conductive traces, and connectors are known in the electronics industry as are methods for manufacturing such electronic system elements. Hardware controllers for controlling touch screens and displays and software for managing display and touch screen systems are well known. These tools and methods are usefully employed to design, implement, construct, and operate the present invention. Methods, tools, and devices for operating capacitive touch screens are used with the present invention.

The drive or sense electrodes 24, 34 can be formed in a variety of patterns. Electrodes can be rectangular and arranged in regular arrays. Drive electrodes 24 and sense electrodes 34 can be arranged orthogonally to each other. Alternatively, electrodes can be arranged using polar coordinates, in circles, or in other curvilinear patterns. Electrodes can have uniform spacing or widths. Alternatively, electrodes can have non-uniform spacing and variable widths.

The present invention is useful in a wide variety of electronic devices. Such devices can include, for example, photovoltaic devices, OLED displays and lighting, LCD displays, plasma displays, inorganic LED displays and lighting, electrophoretic displays, electrowetting displays, dimming mirrors, smart windows, transparent radio antennae, transparent heaters and other touch-screen devices such as capacitive touch screen devices.

The invention has been described in detail with particular reference to certain embodiments thereof, but it will be understood that variations and modifications can be effected within the spirit and scope of the invention.

### PARTS LIST

A cross-section line
D direction
T thickness
X dimension
5 touch-screen device
10 touch screen
11 touch-screen surface
12 substrate
14 substrate surface 20 drive layer
22 drive micro-wires
24 drive electrode
26 drive micro-wire pattern
28 drive circuit
30 sense layer
32 sense micro-wires
34 sense electrode
36 sense micro-wire pattern
38 sense circuit
40 dielectric layer
44 diamond pattern
46 wire grid pattern
60 cover
70 charge curve
72 charge curve
74 charge minimum
76 charge minimum 100 display and touch-screen apparatus
110 display
112 electrically connecting bridge wires
114 electrically connecting wires

### PARTS LIST CONT'D

120 touch screen
122 first transparent substrate
124 dielectric layer
126 second transparent substrate
128 first touch pad area
129 second touch pad area
130 first transparent electrode
132 second transparent electrode
134 wires
136 electrical buss connections
140 touch-screen controller
142 display controller
150 micro-wire
156 micro-pattern
200 provide substrate step
205 form drive electrodes step
210 form sense electrodes step
215 provide cover step
305 coat curable layer step
310 imprint curable layer step
315 cure curable layer step
320 coat cured layer with conductive step
325 remove excess conductive ink step
330 cure conductive ink step

1. A micro-wire touch-screen device that does not experience false release, comprising:
a transparent layer having a surface;
a plurality of drive electrodes formed in relation to the transparent layer, each drive electrode including a plurality of electrically connected drive micro-wires;
a plurality of sense electrodes formed in relation to the transparent layer, each sense electrode including a plurality of electrically connected sense micro-wires, the sense micro-wires electrically isolated from the drive micro-wires;
the transparent layer disposed such that the location of the transparent layer surface is selected to be greater than zero and less than 500 microns from the sense electrodes in a direction perpendicular to the transparent layer surface; and
whereby the drive electrodes and the sense electrodes form a capacitive touch sensor that does not experience false release.

2. The micro-wire touch screen device of claim 1, wherein the transparent layer is a cover.

3. The micro-wire touch screen device of claim 2, wherein the cover includes glass or a polymer.

4. The micro-wire touch screen device of claim 1, wherein the transparent layer is a substrate.

5. The micro-wire touch screen device of claim 1, wherein the sense electrodes and the drive electrodes are formed in separate layers.

6. The micro-wire touch screen device of claim 1, wherein at least some of the sense micro-wires are in a common layer with at least some of the drive micro-wires.

7. The micro-wire touch screen device of claim 1, wherein the sense electrodes are formed in a sense layer and the drive electrodes are formed in a drive layer between the transparent layer and the sense layer.

8. The micro-wire touch screen device of claim 1, wherein the drive electrodes are formed in a drive layer and the sense electrodes are formed in a sense layer between the transparent layer and the drive layer.

9. The micro-wire touch screen device of claim 1, wherein the sense micro-wires are arranged in a sense micro-wire pattern and the drive micro-wires are arranged in a drive micro-wire pattern and the drive micro-wire patterns are the same micro-wire pattern.

10. The micro-wire touch screen device of claim 9, wherein the sense micro-wires are spatially out of phase in one dimension with the drive micro-wires.

11. The micro-wire touch screen device of claim 10, wherein the sense micro-wires are 180 degrees spatially out of phase in one dimension with the drive micro-wires.

12. The micro-wire touch screen device of claim 1, wherein the sense micro-wire pattern or the drive micro-wire pattern are grid or diamond micro-wire patterns.

13. The micro-wire touch screen device of claim 1, further including a dielectric layer located between the drive and sense micro-wires.

14. The micro-wire touch screen device of claim 1, wherein the drive micro-wires or sense micro-wires are cured micro-wires located in micro-channels formed in a cured layer.

15. The micro-wire touch screen device of claim 1, wherein the transparent layer is less than or equal to 400 microns thick.

16. The micro-wire touch screen device of claim 1, wherein the transparent layer is less than or equal to 250 microns thick.

17. The micro-wire touch screen device of claim 1, wherein the transparent layer is less than or equal to 100 microns thick.

18. The micro-wire touch screen device of claim 1, wherein the transparent layer is less than or equal to 50 microns thick.

19. The micro-wire touch screen device of claim 1, further including a sensing circuit electrically connected to the sense micro-wires for sensing charge, capacitance, or current in the sense micro-wires.

20. The micro-wire touch screen device of claim 1, wherein the transparent layer has a dielectric constant greater than 1.5 and a thickness less than 100 microns.
